(19) United States
(12) Patent Application Publication
(10) Pub. No.: US 2004/0202756 A1
(43) Pub. Date: Oct. 14, 2004

(54) Process for the preparation of smoked food products, means to practice said process and food products thus obtained

(76) Inventors: Pierre Holzschuh, Kehl (DE); George Buch, Schutterwald (DE); Jean-Jacques Weiland, Hattmatt (FR)

Correspondence Address: YOUNG & THOMPSON, 745 SOUTH 23RD STREET 2ND FLOOR, ARLINGTON, VA, 22202

(21) Appl. No.: 10/765,839

(22) Filed: Jan. 29, 2004

Related U.S. Application Data
(60) Provisional application No. 60/458,952, filed on Apr. 1, 2003.

(30) Foreign Application Priority Data
Jan. 29, 2003 (FR) 0301002

(51) Int. Cl. C12H 1/10

(52) U.S. Cl. 426/321

(57) ABSTRACT

Process for the preparation of smoked products such as fish, meat, pork products and the like comprises at least one step of flavoring which gives a smoked flavor to the food product and at least one step of coloring, independent from the flavoring step, which gives a supplemental color or a particular supplemental nuance to the food product, in particular by reinforcing the color previously obtained. The invention also relates to an apparatus for the practice of the process and the smoked food products thus obtained.

The present invention relates to the field of agro-food and more particularly that of the treatment of food products permitting essentially improving certain of their organoleptic qualities (appearance, taste . . . ) as well as their preservability (increase in the duration of preservation). It relates more particularly to the preparation by smoking and coloring of smoked food products such as fish, meat, pork products and the like.

Smoking is, with salting, one of the oldest techniques for preserving foodstuffs. Thus, it was discovered shortly after human discovery of fire. At the outset, the object sought was to increase the time of preservation of the treated product. Later, it is principally a matter of the quality of taste and secondarily a way of presenting the product, which prevailed.

Ancient processes have been used up to the last century, but since then, the techniques have been modernized and diversified, the conventional smoking methods representing only a small part of the worldwide volume.

Thus, new products have for example come to light in the United States from the XIX^{th} century. These products, also called liquid smoke or liquid smoke compositions, have been developed to replace the direct contact of the foodstuff with smoke and are obtained by condensing gaseous smokes obtained by pyrolysis of a vegetable organic material, most often wood, in liquid form.

It is thus known that the pyrolysis of vegetable materials, in particular the pyrolysis of particles or chips of wood, leads to the formation of aromatic molecules during the process of thermal decomposition of said vegetable material. The chemical nature of the flavors obtained depends essentially on the treatment parameters, such as the temperature of pyrolysis, the dwell time or else the gaseous atmosphere used in the course of the pyrolysis reaction.

Moreover, most of the chemical compounds constituting the smoke obtained during pyrolysis are liquid at ambient temperature. Because of numerous advantages, these products have tended to constitute progressively the new standard of production of smoked foodstuffs. Thus, the liquid smokes are particularly used advantageously during smoking of ham, sausage, fish, pressed meat etc., a smoked taste as well as a typically brown coloration, similar to those observed during traditional smoking, being thus obtained.

The principal object of smoking food products is thus at present to obtain a taste and coloring typical of the product and, preferably, an improvement in preservability.

The liquid smokes constitute complex mixtures that can comprise more than 1,000 different chemical compounds, of which 400 have been clearly identified. These compounds appear generally in chemical families whose principal components are carboxylic acids, carbonyls, phenols and polycyclic aromatic hydrocarbons.

By way of example of a typical liquid smoke composition can be cited U.S. Pat. No. 3,106,473.

Schematically, it is noted that the organic acids have an action on the preservability of smoked products, that the phenols have an action on the taste of the smoked products and that the carbonyl compounds give rise to the color of the smoked products. However, because of the extreme chemical complexity of liquid smokes, synergism between the various chemical compounds is more than probable.

A certain number of undesirable compounds are also produced during pyrolysis processes. Polycyclic aromatic hydrocarbons (PAH) are toxic compounds produced during high temperature pyrolysis of organic materials. These compounds must be eliminated from the liquid smokes or their content must at least be minimized. The standards at present in force in Europe require a maximum quantity of 10 ppb of benzo[a]pyrene and 20 ppb of benzoanthracene in liquid smokes.

The control of the content of polycyclic aromatic hydrocarbons in liquid smokes thus permits minimizing the sanitary risks relative to the conventional smoking methods.

For the production of aromatic smokes, various pyrolysis reactors have been developed in the course of these last decades.

A new type of reactor described in French patent application No. 02 08495 in the name of the applicant, of the so-called “vibrating elevating reactor” type, comprises essentially a substantially hermetically sealed heatable chamber containing at least one ascending tubular element that is vibrated and receives an organic material to be pyrolyzed, for the production of smoke adapted for smoking food products, for the production of liquid smoke and for the production of wood charcoal.

Another type of suitable reactor is described in French patent application No. 03 00925 of Jan. 28, 2003 in the name of the applicant, and comprises a heatable chamber containing at least one rotatable endless screw heated by the Joule effect receiving the organic material to be pyrolyzed.

Such reactors permit obtaining smoke suitable for the smoking of food products which will be technically satisfactory and which meet the applicable sanitary standards, which is to say that they have a maximum content by volume of benzo[a]pyrene of 10 μg/m³ and 20 μg/m³ by volume of benzoanthracene, or, once condensed as liquid smoke, a volume content of benzo[a]pyrene of at most 10 ppb and a volume content of benzoanthracene of at most 20 ppb.

However, all the processes for treating food products now in use have the drawback of not permitting a selective preparation of the product to be treated as a function of its original organoleptic properties.

Thus, for example, it is not at present possible to reinforce independently the intensity of the taste, of the color and of the duration of preservation of a food product of the type mentioned above, without thereby affecting its other properties.

In particular, there does not exist at the present time a smoking process permitting modifying the color of a food product to be treated without also modifying the taste. The reinforcement of the color that is obtained by smoking said product is also accompanied by an increase of the intensity of taste which can ultimately lead to de-naturation, rendering the treated product unsatisfactory or even unsuitable for consumption.

The present invention has for its object to overcome at least certain of the mentioned drawbacks.

To this end, it has for its object a process for the preparation of a food product, characterized in that it comprises essentially at least one step of flavoring consisting in giving a smoked flavor to said food product and at least one step of coloring, independent of said flavoring step, consisting in giving a supplemental color or a particular supplemental nuance to said food product, in particular by reinforcing the color previously obtained.

It also has for its object a food product obtained by the practice of the process according to the invention as well as a preservation agent for food products for practicing said process according to the invention.

Finally, it also has for its object the use of a composition containing at least one carbonylated substance other than hydroxyacetaldehyde and reducing sugars for coloring by Maillard reactions a food product.

The invention will be better understood from the following description, which relates to preferred embodiments, given by way of non-limiting examples.

According to a first aspect, the process according to the invention is characterized in that it comprises moreover a step of preservation, independent of said flavoring and coloring steps, consisting in placing the food product to be prepared or already partially prepared into contact with at least one preservation compound obtained by pyrolysis of at least one vegetable material and/or comprising at least one compound selected from the group formed by preservatives of CE number selected from the following list: E 200, E 202, E 203, E 210, E 211, E 212, E 213, E 235, E 249, E 250, E 251, E 252, E 260, E 262, E 263, E 270, E 300, E 301, E 325, E 326, E 330 and E 334.

Moreover, it has been noted that the presence of organic acids, emitted during the smoking process, permits increasing the lifetime of preservation of the food products.

Thus, preferably, the step of preservation is carried out by applying to said food product a smoke obtained by pyrolysis of at least one organic vegetable material at a temperature comprised between 150° C. and 300° C., preferably between 200° C. and 280° C., if desired followed by a supplemental step of purification of the produced smoke, so as to reduce to an acceptable concentration the content of undesirable compounds of the type of polycyclic aromatic hydrocarbons (TAH), phenolic compounds and the like.

According to a modification, the step of preservation takes place by applying to said food product a liquid smoke obtained by pyrolysis of at least one organic vegetable material at a temperature comprised between 150° C. and 300° C., preferably between 200° C. and 280° C., if desired followed by a supplemental step of purifying the produced smoke, so as to reduce to an acceptable concentration the content of undesirable compounds of the polycyclic aromatic hydrocarbon (HAP) type, phenolic compounds and the like, said produced smoke, if desired purified, being condensed in the form of a liquid once produced in a suitable condensation device.

According to another important characteristic, the step of flavoring takes place by applying to said food product, a smoke obtained by pyrolysis of at least one organic vegetable material at a temperature comprised between 200° C. and 800° C., preferably between 300° C. and 400° C., if desired followed by a supplemental purification step for the produced smoke when said pyrolysis temperature is comprised between 400° C. and 800° C., so as to reduce to an acceptable concentration the content of undesirable compounds of the polycyclic aromatic hydrocarbon (PAH) type.

In this connection, it should be remembered that the smoked flavor is obtained by the absorption of aromatic molecules from the smoke by the food product. The aromatic molecules are principally comprised by phenols and heterocyclics such as furans.

In another embodiment, the process according to the present invention is characterized in that the flavoring step takes place by applying to said food product, a liquid smoke obtained by pyrolysis of at least one organic vegetable material at a temperature comprised between 200° C. and 800° C., preferably between 300° C. and 400° C., if desired followed by a supplemental purification step for the produced smoke when said pyrolysis temperature is comprised between 400° C. and 800° C., so as to reduce to an acceptable concentration the content in undesirable compounds of the polycyclic aromatic hydrocarbon (PAH) type, the produced smoke, if desired purified, being condensed in liquid form once produced in a suitable condensation device.

Preferably, the pyrolysis takes place under precise control, to about 0.1% and/or to about one degree Celsius of the content by volume of oxygen during said pyrolysis, respectively of the pyrolysis temperature.

According to another aspect, the pyrolyzed organic material is essentially constituted by fibers or chips of at least one vegetable substance such as wood, cellulose or any other mono or polysaccharide or ligno-cellulosic complex.

Preferably, the pyrolysis takes place in a vibrating elevating reactor of the type comprising essentially a substantially hermetically sealed heatable chamber containing at least one ascending tubular element in vibration and receiving an organic material to be pyrolyzed, for the production of smoke or liquid smoke adapted to the smoking of food products.

According to another modification that is also advantageous, the pyrolysis takes place in a reactor comprising essentially a substantially hermetically sealed heatable chamber containing at least one rotatable endless screw heated by the Joule effect, said at least one screw receiving an organic material to be pyrolyzed, for the production of smoke adapted for smoking food products.

According to another advantageous characteristic, the process according to the invention is also characterized in that the liquid smoke used has, once condensed, a volume content of benzo[a]pyrene of at most 10 ppb and a volume content of benzoanthracene of at most 20 ppb.

The coloration of the smoke product is itself principally due to the so-called Maillard reactions between the carbonyl functions present in said smoke and the proteins of the food product to be smoked.

In a first embodiment, the step of coloring is carried out by performing Maillard reactions on the food product to be prepared or already partially prepared.

According to another embodiment, the coloring step takes place by placing the food product to be colored into contact with a composition containing at least one carbonylated substance other than the hydroxyacetaldehyde of the reducing sugars.

Preferably, the step of coloring takes place by placing the food product to be colored into contact with a composition containing at least one substance selected from the group formed by hexadecanal, glutaraldehyde, 2-ethylhexanal, farnesal, 2-butenal, 2-methylhexanal, glyoxal, 2-methylpentanal, neral, tridecanal, 2-hexanal and 2-propenal.

Alternatively, the coloring step takes place by placing the food product to be colored into contact with an aminated composition containing at least one amino acid.

According to another characteristic, the coloring step takes place by placing the food product to be colored into contact with at least one coloring composition comprising at least one colorant selected from the group formed by carmine, caramel, paprika, annatto, sandalwood and by colorants of CE number selected from the following list: E 100, E 101, E 102, E 104, E 110, E 120, E 122, E 123, E 124, E 127, E 128, E 129, E 131, E 132, E 133, E 140, E 141, E 142, E 150a, E 150b, E 150c, E 150d, E 151, E 153, E 154, E 155, E 160a, E 160b, E 160c, E 160d, E 160e, E 160f, E 161b, E 161g, E 162, E 163, E 170, E 171, E 172, E 173, E 174, E 175 and E 180.

In a particularly preferred manner, the process according to the invention is characterized in that one, several or all the steps among those of flavoring, coloring and preservation, are carried out by independent spraying of liquid compositions ready to use, obtained from the flavoring, coloring and conservation composition or compositions, on the food product to be prepared or already partially prepared.

Preferably, one, several or all the steps among those of flavoring and preservation are carried out by smoking of the food product to be prepared or already partially prepared.

The present invention also has for its object a food product obtained by the practice of the process according to the invention as well as a preservation agent for a food product, for practicing said process according to the invention, characterized in that it consists in a smoke obtained by pyrolysis of at least one organic material at a temperature comprised between 150° C. and 300° C., preferably between 200° C. and 280° C., if desired followed by a supplemental purification step of said smoke, this so as to reduce to an acceptable concentration the content of undesirable compounds of the type of polycyclic aromatic hydrocarbons (PAH), phenolic compounds and the like.

Preferably, the preservation agent for foodstuffs for practicing the process according to the invention is characterized in that it consists of a liquid smoke obtained by pyrolysis of at least one organic material at a temperature comprised between 150° C. and 300° C., preferably between 200° C. and 280° C., if desired followed by a supplemental step of purification of the produced smoke, so as to reduce to an acceptable concentration the content in undesirable compounds of the type of polycyclic aromatic hydrocarbons (PAH), phenolic compounds and the like, said produced smoke, if desired purified, being condensed in liquid form once produced in a suitable condensation device.

Preferably, the preservation agent according to the present invention is characterized in that it has a content of carboxylic acid resulting from pyrolysis, comprised between 1% and 50% by weight.

Finally, it also has for its object, the use of a composition containing at least one carbonylated substance other than hydroxyacetaldehyde and reducing sugars, for coloring by Maillard reactions a food product. This use is characterized in that the composition contains at least one substance selected from the group formed by hexadecanal, glutaraldehyde, 2-ethylhexanal, farnesal, 2-butenal, 2-methylhexanal, glyoxal, 2-methylpentanal, neral, tridecanal, 2-hexanal and 2-propenal.

As explained above, the process of the present invention permits the production of smoked food products having a taste profile identical or almost identical to that obtained by conventional smoking as well an intense color and good preservability of the smoked product.

The present invention also permits providing a process for the production of smoked food products whose intensity of flavor, duration of preservation as well as intensity of coloration can be freely and independently determined by the user of the present invention.

As explained above, the flavoring liquid smoke used in the scope of the present invention is comprised essentially of phenols and heterocyclics such as furans. The flavor profile of this liquid smoke is identical or almost identical to that obtained by conventional smoking methods. This is made possible particularly by strict control of the parameters of pyrolysis of the wood, such as temperature, oxygen content, etc.

Such a process for production of a liquid smoke is described in French applications Nos. 02 08495 of Jul. 5, 2002 and 03 00925 of Jan. 28, 2003 in the name of the applicant.

The smoke (if desired liquid) has a good coloring power and is comprised essentially of carbonyls adapted to initiate said Maillard reactions with the proteins of the food. It can also contain aminated acids or proteins so as to accelerate and intensify said Maillard reactions. Such solution are for example obtained by fractionation or distillation of smoke, pyrolysis of vegetable material or the addition of natural or synthetic carbonylated compounds.

As set forth above, the present invention also provides for the use of natural or synthetic food colorings (for example carmine, caramel, paprika, annatto, E 124 . . .) so as to reinforce, modify or adjust the color of the product to be smoked.

The preservative agent (for example a liquid solution with a high preservative power) contains essentially one or several carboxylic acids such as acetic acid, formic acid, propanoic acid, butanoic acid, maleic acid, etc . . . These solutions are obtained by fractionation or distillation of the smoke, by low temperature pyrolysis of vegetable materials or else by the addition of natural or synthetic compounds.

The specific pyrolysis at low temperature (150° C.-300° C.) according to the invention of vegetable materials is particularly advantageous for the production of liquid solutions with a high preservative power.

Thus, it is known that the vegetable material is principally comprised of cellulose, hemicelluloses and lignins. However, a low temperature pyrolysis such as defined above permits preferentially degrading the polysaccharides (cellulose and hemicelluloses) which originate from the formation of carboxylic acids. The lignin is thus little degraded and the content of phenols emitted is relatively low.

The liquid solution thus obtained is accordingly rich in carboxylic acids but poor in phenols.

The use of these liquid solutions by operative processes such as vaporization or spraying (reconstitution of a mist of smoke in the cooking cell), douching, quenching, direct addition or other type of procedure permits the user to determine the intensity of flavor, the final coloration and the preservability of the smoked product.

The use of food colorings such as particularly carmine, paprika, annatto, etc. in combination or not with a (liquid) flavoring smoke, a preservative agent (for example, a solution with a high preservative power), a coloring agent (for example, a solution for coloring by the Maillard reaction) so as to intensify, modify or adjust the color of the product, is particularly advantageous during implementation by proceeding with spraying because it permits economy of manual labor and leads to a more homogeneous shade of the food product. An economy as to the quantities of products used is also enjoyed relative to processes such as douching or quenching.

The direct mixing of the different liquid solutions that can be used being often rendered difficult by the presence of compounds that are hardly hydrosoluble, essentially present in the flavoring liquid smoke, which have the tendency to give rise to precipitation of a portion of the aromatic fraction, it is preferred to use separately different solutions and liquid smoke, which permits enjoying to the fullest the taste profile and the coloring power of the mentioned solutions that are used.

An alternative to the use of solutions and liquid smoke described in this invention is the use in situ, which is to say in the treatment cell itself, of the foodstuffs to be prepared, of specific smoke generators.

Thus, the smoke generators as described in the French applications mentioned above, permits the production of smoke with a high flavoring potential, a high coloring potential or a high preservative potential by the use of various parameters of pyrolysis and by a judicious choice of the pyrolyzed vegetable material.

Preferably, the pyrolysis temperature can be adjusted so as to reduce a wood smoke rich in phenols (degradation of the lignin of the wood between about 330° C. and 400° C.), a smoke rich in carbonylated compounds (pyrolysis at more than 400° of vegetable materials not containing lignin) or a smoke with a high preservative potential (pyrolysis of wood or vegetable materials between about 150° C. and 300° C.).

The separate or sequential use of such smoke generators permits the user freely and independently to fix the intensity of flavor, color and preservability of the treated food products.

The following non-limiting examples permit better understanding the advantages of the present invention:

### EXAMPLE 1

Pork breast was smoked with the help of two solutions obtained from liquid smoke.

The first is a liquid smoke (hereinafter called FL1) permitting principally giving a smoked flavor identical to the conventional smoked flavor. The physico-chemical characteristics of this liquid smoke are as follows:

| Density: | 1.1 kg/l |
|---|---|
| pH: | 1.9 |

Chromatographic gas phase analyses (weight percent):

| | |
|---|---|
| acids (acetic acid): | 18% |
| phenols: | 35 mg/ml |
| furans: | 26 mg/ml |

This liquid smoke was obtained by pyrolysis of beech wood by using parameters of the process of production similar to those used in a conventional smoker and according to the principle described in French application No. 02 08495 mentioned above (temperature of the order of 350° C. and oxygen content <0.2 vol. %).

Gas chromatographic analysis coupled with a mass spectrometric detection permits detecting and quantifying the principal molecules present in the solution. The phenol profile is very different from the liquid smokes obtained by the processes of known type under the name of “fast pyrolysis” or else “flash pyrolysis” in the state of the art but absolutely similar to the flavor profile obtained during traditional smoking.

The second liquid smoke (hereafter called FL2) is comprised essentially by carbonylated compounds and has a density of 1.05 kg/l. It is obtained by pyrolysis of polysaccharides at high temperature (T>600° C.) followed by a purification step.

Gas phase chromatographic analyses (weight percents):

| | |
|---|---|
| acids (acetic acid): | <0.5% |
| phenols: | <1 mg/ml |
| furans: | <1 mg/ml |
| carbonyls: | 12.8% |

The intensity of flavor is determined by a sensory evaluation whilst the color is determined by colorimetric measurement according to the CIELab (system of trichromatic coordinates L* a* b*) with the help of a MINOLTA spectrocolorimeter.

The solutions of liquid smoke are applied by spraying before cooking at 60° C. for 1 hour and 15 minutes.

The sensory analyses disclose the presence of a very soft and very round smoked flavor quite similar to the conventional smoked flavor for specimens treated with the help of flavoring liquid smoke. The specimens treated with the help of smoke with high coloring power do not have a significant smoked flavor. The results of the colorimetric analysis are presented in the following Table I:

TABLE I

| Specimen | L* | a* | b* |
|---|---|---|---|
| Standard pork | 60.8 | 6.0 | 23.6 |
| chest | | | |
| Pork chest + | 49.2 | 14.3 | 20.1 |
| flavoring smoke | | | |
| Pork chest + | 50.7 | 12.0 | 17.9 |
| coloring smoke | | | |
| Pork chest + | 42.0 | 11.5 | 16.1 |
| flavoring smoke + | | | |
| coloring smoke | | | |

This example shows the possibility of obtaining smoked products having a flavor profile and a color that are identical, or even superior to, products smoked by conventional smoking whilst using liquid smokes.

The flavoring liquid smoke also contributes to the coloring of the food product by mechanisms substantially different from the Maillard reactions and by the presence of carbonyl functions for certain aromatic molecules (furans in particular).

The coloring smoke permits intensifying discoloration by the Maillard reaction. The concentration and the quantity of product used permit the user to adjust the final color and the intensity of the final color of the product.

The action of the smoke with a high flavor potential permits adjusting the intensity of smoked flavor by acting on the parameters such as the smoking time, the concentration of the product or else the quantity of product used. A base color cannot be avoided.

The action of the smoke with a high coloring power permits intensifying the initial color (base color) of the product without modification of the taste.

### EXAMPLE 2

Tests of miscibility between smokes with a high flavoring power and a high coloring power have been carried out. A smoke with a high flavoring power (FL1) is mixed with a liquid smoke with a high coloring power (FL2).

The compositions resulting from these mixtures are given in Table II below (percentages expressed by weight).

TABLE II

| | | FL1 + | FL1 + 10% | FL1 + 20% | FL1 + 30% |
|---|---|---|---|---|---|
| Composition | FL1 | 5% FL2 | FL2 | FL2 | FL2 |
| carbonyls | 37 | 29 | 27 | 23 | 23 |
| (g/l) | | | | | |
| heterocycles | 37 | 33 | 33 | 24 | 23 |
| (g/l) | | | | | |
| acids (g/l) | 151 | 143 | 139 | 110 | 102 |
| phenols | 34.2 | 27.4 | 25.9 | 19.8 | 15.8 |
| (g/l) | | | | | |

Apart from the phenomenon of dilution, the mixtures obtained no longer contain all the phenols present in FL1.

A precipitation is observed during mixture of FL1 with FL2, a portion of the phenols that are little hydrosoluble present in FL1 leading to the formation of a tarry fraction at the beginning of the observed precipitation.

The liquid smoke FL1 however has a large quantity of carboxylic acids which contribute to improving the solubility of the little hydrosoluble compounds (phenols, furans . . .). This liquid smoke causes less precipitation than most of the liquid smokes now present on the market.

This example shows the necessity of using separately the solutions and liquid smokes for flavoring, coloring and preservation.

A possible use by spraying of these solutions and specific liquid smokes is the use of several dissociated injection circuits. One of the circuits is used to spray the liquid smoke with a high flavoring power whilst the other spraying circuits permit subjecting the product to the liquid smoke with a strong flavoring power, to a solution containing the food colorings or to a liquid solution with a high preservative power.

A sequential spraying of these different liquid solutions (flavoring liquid smokes, coloring liquid smoke or food coloring, smoke with a high preservative power) is also possible. The food product is subjected alternately to the action of one or the other of the liquid solutions.

A mixture of the liquid solutions (flavoring liquid smoke, coloring liquid smoke or food coloring) upstream of the spray nozzle however remains possible.

The addition of surface active agents, polysorbates, etc., for solubilizing the different solutions, is thus necessary but may eventually lead to a modification of the properties of adsorption and absorption of the smoke and liquid solutions at the surface of the food product.

The use of quenching is made possible by the use of separate baths for each of the specific liquid smokes or food colorings.

The use of douching is rendered possible by the use of separate douches for each of the specific liquid smokes or food colorings.

### EXAMPLE 3

The flavoring liquid smoke obtained by the process described by French application No. 02 08495 has a quantity of carboxylic acids (acetic acid, formic acid, propanoic acid, butanoic acid, etc.) that is high, which permits increasing the solubility of the little-hydrosoluble compounds such as the phenols and the furans in this liquid smoke.

This liquid smoke permits attenuating the phenomena of precipitation in contact with water relative to most of the commercial liquid smokes now on the market which contain less carboxylic acid.

Another advantage is an improvement in the preservation of the food products by the preservative action of the organic acids and the phenols present in large quantities in the liquid smoke.

Frankfort sausages have been smoked by spraying with the help of a liquid smoke A produced according to the process described by French application No. 02 08495 from beech wood pyrolyzed at a temperature of 290° C. (oxygen content<0.1 vol. %) and whose characteristics are the following:

| Density: | 1.03 kg/l |
|---|---|
| pH: | 1.8 |

Gas phase chromatographic analyses (weight percents):

| | |
|---|---|
| acids (acetic acid): | 22.4% |
| phenols: | 5.3 mg/ml |
| furans: | 12.4 mg/ml |

The same sausages have been subjected to the action of a liquid smoke B (obtained by “flash” pyrolysis of hickory wood at a temperature of the order of 700° C.), under the same conditions as with liquid smoke A and having the following composition:

Smoke B

| density: | 1.1 kg/l |
|---|---|
| pH: | 2.9 |

Gas phase chromatographic analyses (weight percents):

| | |
|---|---|
| acids (acetic acid) | 8.6% |
| phenols: | 19 mg/ml |
| furans: | 20 mg/ml |

A bacteriological study has been conducted so as to compare the preservative effect of these liquid smokes:

The sausages were preserved 15 days at 4° C.

The results of bacteriologic analyses carried out at the end of 15 days are given in the following Table III.

TABLE III

| | Unsmoked | Smoked | Smoked |
|---|---|---|---|
| | sausages | sausages A | sausages B |
| Mesophilic | 10 000 000/g | 200 000/g | 1 400 000/g |
| flora | | | |
| Yeast | 10 000/g | <100/g | <100/g |
| Mold | 1 500/g | <100/g | 1000/g |

It appears clearly that liquid smoke A confers on the food product a better preservation than smoke B. This seems particularly due to the chemical composition, rich in carboxylic acids of liquid smoke A.

It thus becomes possible for the producer of smoked food products to adjust freely the intensity of the flavor, the preservability and the color of the smoked product. Similarly, the use of food colorings permits the user to correct or to refine the color of said product.

The process according to the present invention thus permits producing smoked products having a taste similar to or even identical to that obtained by conventional smoking whilst having an improved aesthetic appearance and preferably duration of preservation (limit date of consumption, LDC) increased.

Preferably, the liquid smokes used in the present invention are obtained by the process described by French applications Nos. 02 08495 of Jul. 5, 2002 and 03 00925 of Jan. 28, 2003 using a vibrating reactor or provided with an endless rotating screw heated by the Joule effect. Thus, one of the essential advantages of the use of these reactors consists in permitting a continuous thermal treatment of vegetable materials with strict control of the treatment parameters. The possibility of treatment of the two types of reactors mentioned above permits producing smokes and liquid smokes with a perfectly controlled pyrolysis of the vegetable material. The liquid smokes thus obtained can be used by spraying an air-distillate mixture of smoke directly into the cell for smoking, quenching, douching or else by direct addition to the food product. The smoke does not contain tar or noxious polycyclic aromatic hydrocarbons. The smoke thus produced corresponds to all the flavor fraction from pyrolysis of the wood obtained by conventional processes.

A reactor of the EVER (electrically vibrated elevating reactor) particularly well adapted to the process according to the present invention is that sold by the company REVTECH (Charmes sur Rhône), which is the object of French patent application No. 91 10 935 published under No. FR 2 680 638 A1.

A treatment oven similar to that described in this patent, in German application DE 35 04 950 or any other type of suitable vibrated oven, independent of the source of heat employed to trigger the pyrolysis reaction properly so called, will also suffice as pyrolysis reactors usable in the scope of the process of the present invention and this latter is thus not limited to these two particular types of device.

Such a reactor of the EVER type preferably combines the technology of transporting the particles by vibration and the technology of the tube with a current passage, and thus permits access to developed techniques for thermal treatment of divided solids. This reactor thus permits the thermal treatment continuously of the organic material to be pyrolyzed. The transport of the organic material to be pyrolyzed is ensured therein by vibration according to the principle of elevating coils. The organic material to be pyrolyzed is introduced in a conventional way (manual or automatic supply, hopper . . . ) at one of the ends (preferably the lower end) of the tubular element or elements and moves under the influence of vibrations imparted to said tubes to the other end (preferably the upper end) where it is recovered in a manner that is also conventional (recovery bin or the like). The vibrations can for example be generated by a vibrating table moved by a motor member capable of communicating to said table vibratory movements in a horizontal plane, for example a rotation, and vibrations in the vertical direction. To this end, the vibrations can be generated in a known manner by motors with eccentric weights or any other equivalent device.

The tubular element or elements pass through a fixed chamber which permits adding calories and raising the temperature of said tubular element or elements either directly or indirectly. By way of preferred example, the passage of an electric current through the transport tube permits generating heat by the Joule effect in the body of the tube.

The tubular element or elements can be constituted by a serpentine of stainless steel completely closed. The treatment atmosphere can thus be strictly controlled. The treatment of the organic material can thus be carried out under an inert gas (nitrogen or any other inert gas), under a partially oxidizing gas (nitrogen/oxygen mixture with different concentrations of oxygen) or else under carbon dioxide or under a recycle of the produced smoke (recycling of the pyrolysis gas during thermal treatment).

In a particularly preferred manner, the produced smoke is condensed at the outlet of the reactor in a suitable condensation device and according to a particularly economical modification, at least one portion of the pyrolysis gas present at the outlet of the condensation device is re-injected into the reactor.

The dwell time of the organic material to be pyrolyzed can also be fixed in a precise manner. Thus, the technology of the vibrating tube permits a “piston” flow of the material to be treated. Thus, the inclination of the motors with eccentric weights as well as the frequency and amplitude of the vibrations, permit controlling the dwell time of said material in the reactor. This dwell time can vary, according to conditions, from several seconds to about 30 minutes.

The technology of transport by vibrating tube permits treating divided solids with a wide granulometry permitting using a wide range, from micro-powders to pieces of several centimeters of organic material.

As explained, the pyrolysis temperature (from 150° C. to 300° C. or 200° C. to 800° C.) as well as the temperature profiles are perfectly controlled to about one degree. The possibility of an electrical architecture permitting using several independent heating zones permits, as the case may be, controlling the heat profile of treatment of the vegetable material. The emplacement of a cooling zone, by use of several non-heated spirals or a double envelope containing a cold fluid, permits obtaining low and constant temperatures of the pyrolyzed material at the outlet of the reactor.

The thermal decomposition of the organic material and particularly of the wood in the scope of the present invention, is preferably obtained at relatively low pyrolysis temperatures with the help of reactors of the EVER type (principally between 150° C. and 300° C.). The smoke and liquid smoke thus contain fewer polycyclic aromatic hydrocarbons which are generally formed at higher pyrolysis temperatures.

A homogeneous thermal treatment of organic material with a variable granulometry (for example wood sawdust of several microns to several centimeters) is possible by “piston” advance of the material in the reactor and by intimate contact between the vegetable material and the hot tube. The “piston” flow permits controlling with precision the temperature of the material and the dwell time.

The heating is ensured by conduction between the tube and the vegetable material. The process does not require the use of large quantities of gas to be managed or de-polluted. The risks of cold zones (soot traps) is minimized.

The sealing of the system, without mechanical members, permits minimizing the risks of emitted odors and of the exposure of personnel to pyrolysis gases. The cleaning of the installation is easy by pyrolysis in air, by circulation of cleaning liquid in the coils or else by a scraper.

The thermal efficiency of the apparatus is nearly 80% by intimate contact between the vegetable material and the hot transport tube as well as a complex combination of conduction, induction and radiation toward the product to be heated.

The vibrating tube transport does not give rise to abrasion of the organic material to be pyrolyzed and limits the emissions of charcoal particles. The clogging of the reactor by soot deposits is not great.

Accordingly, reactors of the type described above can be preferably employed for the production of smoke. Thus, the process using vibrating tubular elements permits producing a smoke whose quality and concentration are perfectly controlled whilst minimizing the risk of fire.

Similarly, a reactor of the type known by the term “SPIRAJOULE” sold by the ETIA company (Compiègne, France) and described in French patent application No. FR 2 775 621 permits controlled pyrolysis of vegetable materials.

The advancement of the material in the reactor is ensured by a mixing member (endless screw) which permits piston flow of the vegetable material to be pyrolyzed and also constitutes the heating means. The totality or almost totality of the beginning raw materials will thus be heated directly by contact with said heating means and this without remaining stationary on the heating surface. The heating of said materials is thus carried out in a uniform manner. The mixing member is made of an electrically conductive material so as to generate heating by the Joule effect during passage of current through said mixing member.

Such a generator permits pyrolyzing the vegetable material to within about one degree Celsius, the hermetically sealed chamber permitting controlling the composition of the atmosphere prevailing therein and particularly the quantity of oxygen present in the pyrolysis reactor.

Under these conditions, the smoke produced by the process according to the invention can be totally standardized and is advantageously free or almost free from tar and noxious polycyclic aromatic hydrocarbons.

Moreover, said smoke can be diluted with hot air or any other gas at the outlet of the reactor so as to produce more or less concentrated smoke. It can thus enter directly into a smoking cell, without another processing or purification step.

The use of the process according to the present invention thus permits producing smoke with a high output and without the production of tar or polycyclic aromatic hydrocarbons (PAH) in contrast to the reactors and generators of smoke at present on the market.

The liquid smoke obtained according to the invention is rich in aromatic compounds (phenyls) and in carbonyls. These latter are the source of coloration that is particularly effective and realistic of smoked products with smoke according to the invention, due to the Maillard reactions with the proteins contained in said treated food products.

Of course, the invention is not limited to the described embodiment. Modifications remain possible, particularly as to the constitution of the various elements or by substitution of technical equivalents, without thereby departing from the scope of protection of the invention.

1. Process for the preparation of a food product, characterized in that it comprises essentially at least one step of flavoring consisting in giving a smoked flavor to said food product and at least one step of coloring, independent of said flavoring step, consisting in giving a supplemental color or particular supplemental nuance to said food product, in particular by reinforcing the color previously obtained.

2. Process according to claim 1, characterized in that it comprises moreover a step of preservation, independent of said steps of flavoring and coloring, consisting in placing the food product to be prepared or already partially prepared into contact with at least one preservation product obtained by pyrolysis of at least one vegetable material and/or comprising at least one compound selected from the group formed by preservatives or CE number selected from the following list: E 200, E 202, E 203, E 210, E 211, E 212, E 213, E 235, E 249, E 250, E 251, E 252, E 260, E 262, E 263, E 270, E 300, E 301, E 325, E 326, E 330 and E 334.

3. Process according to claim 2, characterized in that the preservation step is carried out by applying to said food product a smoke obtained by pyrolysis of at least one organic vegetable material at a temperature comprised between 150° C. and 300° C., preferably between 200° C. and 280° C., if desired followed by a supplemental step of purification of the produced smoke, so as to reduce to an acceptable concentration the content of undesirable compounds of the type of polycyclic aromatic hydrocarbons (PAH), phenolic compounds and the like.

4. (original) Process according to claim 2, characterized in that the preservation step takes place by applying to said food product a liquid smoke obtained by pyrolysis of at least one vegetable organic material at a temperature comprised between 150° C. and 300° C., preferably between 200° C. and 280° C., if desired followed by a supplemental step of purification of the produced smoke, so as to reduce to an acceptable concentration the content of undesirable compounds of the type of polycyclic aromatic hydrocarbons (PAH), phenolic compounds and the like, said produced smoke, if desired purified, being condensed in liquid form once produced in a suitable condensation device.

5. Process according to claim 1, characterized in that the flavoring step takes place by applying to said food product, a smoke obtained by pyrolysis of at least one vegetable organic material at a temperature comprised between 200° C. and 800° C., preferably between 300° C. and 400° C., if desired followed by a supplemental step of purification of the produced smoke when said pyrolysis temperature is comprised between 400° C. and 800° C., so as to reduce to an acceptable concentration the content of undesirable compounds of the type of polycyclic aromatic hydrocarbons (PAH).

6. Process according to claim 1, characterized in that the flavoring step takes place by applying to said food product a liquid smoke obtained by pyrolysis of at least one organic vegetable material at a temperature comprised between 200° C. and 800° C., preferably between 300° C. and 400° C., if desired followed by a supplemental step of purification of the produced smoke when said pyrolysis temperature is comprised between 400° C. and 800° C., so as to reduce to an acceptable concentration the content of undesirable compounds of the type of polycyclic aromatic hydrocarbons (PAH), the smoke produced, if desired purified, being condensed in liquid form once produced in a suitable condensation device.

7. Process according to claim 2, characterized in that the pyrolysis takes place under precise control, to about 0.1%, of the volume of oxygen during said pyrolysis.

8. Process according to claim 2, characterized in that the pyrolysis takes place under precise control, to about one degree Celsius, of the pyrolysis temperature.

9. Process according to claim 2, characterized in that the organic pyrolyzed material is essentially constituted by fibers or chips of at least one vegetable substance such as wood, cellulose or any other mono or polysaccharide or ligno-cellulose complex.

10. Process according to claim 2, characterized in that the pyrolysis takes place in a vibrated elevating reactor of the type comprising essentially a heatable chamber substantially hermetically sealed containing at least one ascending tubular element that is vibrated and receiving an organic material to be pyrolyzed, for the production of smoke or a liquid smoke adapted for the smoking of food products.

11. Process according to claim 2, characterized in that the pyrolysis takes place in a reactor comprising essentially a substantially hermetically sealed heatable chamber containing at least one rotating endless screw heated by the Joule effect, said at least one screw receiving an organic material to be pyrolyzed, for the production of smoke adapted for smoking food products.

12. Process according to claim 4, characterized in that the liquid smoke used has, once condensed, a volume content of benzo[a]pyrene of at most 10 ppb and a volume content of benzoanthracene of at most 20 ppb.

13. Process according to claim 1, characterized in that the coloring step is carried out by performing Maillard reactions on the food product to be prepared or already partially prepared.

14. Process according to claim 13, characterized in that the coloring step takes place by placing the food product to be colored into contact with a composition containing at least one carbonylated substance other than hydroxyacetaldehyde and reducing sugars.

15. Process according to claim 14, characterized in that the coloring step takes place by placing the food product to be colored into contact with a composition containing at least one substance selected from the group formed by hexadecanal, glutaraldehyde, 2-ethylhexanal, farnesal, 2-butenal. 2-methylhexanal, glyoxal, 2-methylpentanal, neral, tridecanal, 2-hexanal and 2-propenal.

16. Process according to claim 13, characterized in that the coloring step takes place by placing the food product to be colored into contact with an aminated composition containing at least one amino acid.

17. Process according to claim 1, characterized in that the coloring step takes place by placing the food product to be colored into contact with at least one coloring composition comprising at least one colorant selected from the group formed by carmine, caramel, paprika, annatto, sandalwood and by the colorants of CE number selected from the following list: E 100, E 101, E 102, E 104, E 110, E 120, E 122, E 123, E 124, E 127, E 128, E 129, E 131, E 132, E 133, E 140, E 141, E 142, E 150a, E 150b, E 150c, E 150d, E 151, E 153, E 154, E 155, E 160a, E 160b, E 160c, E 160d, E 160e, E 160f, E 161b, E 161g, E 162, E 163, E 170, E 171, E 172, E 173, E 174, E 175 and E 180.

18. Process according to claim 1, characterized in that one, several or all of the steps among them flavoring, coloring and preservation, are carried out by separate spraying of liquid compositions ready to use obtained from the flavoring, coloring or preservative compositions, onto the food product to be prepared or already partially prepared.

19. Process according to claim 1, characterized in that one, several or all of the steps among them flavoring and preservation are carried out by smoking the food product to be prepared or already partially prepared.

20. Food product obtained by the practice of the process according to claim 1.

21. Preservative agent for food products for the practice of the process according to claim 3, characterized in that it consists in a smoke obtained by pyrolysis of at least one organic material at a temperature comprised between 150° C. and 300° C., preferably between 200° C. and 280° C., if desired followed by a supplemental purification step of said smoke, so as to reduce to an acceptable concentration the content of undesirable compounds of the type of polycyclic aromatic hydrocarbons (PAH), phenolic compounds and the like.

22. Preservative agent for food products for the practice of the process according to claim 4, characterized in that it consists of a liquid smoke obtained by pyrolysis of at least one organic material at a temperature comprised between 150° C. and 300° C., preferably between 200° C. and 280° C., if desired followed by a supplemental step of purification of the produced smoke, so as to reduce to an acceptable concentration the content of undesirable compounds of the type of polycyclic aromatic hydrocarbons (PAH), phenolic compounds and the like, said produced smoke, if desired purified, being condensed in the form of a liquid once produced in a suitable condensation device.

23. Preservative agent according to claim 21, characterized in that it has a content of carboxylic acids arising from pyrolysis comprised between 1% and 50% by weight.

24. Use of a composition containing at least one carbonylated substance other than hydroxyacetaldehyde and reducing sugars for the coloring by Maillard reactions of a food product.

25. Use according to claim 24, characterized in that the composition contains at least one substance selected from the group formed by hexadecanal, glutaraldehyde, 2-ethylhexanal, farnesal, 2-butenal, 2-methylhexanal, glyoxal, 2-methylpentanal, neral, tridecanal, 2-hexanal and 2-propenal.
